(19) United States
(12) Patent Application Publication
(10) Pub. No.: US 2025/0158086 A1
(43) Pub. Date: May 15, 2025

(54) METHOD FOR MANUFACTURING REINFORCED COMPOSITE MEMBRANE USING GANTRY SLOT DIE COATER, REINFORCED COMPOSITE MEMBRANE, AND FUEL CELL INCLUDING THE SAME

(71) Applicant: KOREA UNIVERSITY OF TECHNOLOGY AND EDUCATION INDUSTRY-UNIVERSITY COOPERATION FOUNDATION, Cheonan-si (KR)

(72) Inventors: Jin Woo BAE, Seoul (KR); Dong Heon HAN, Dangjin-si (KR); Woong HEO, Wonju-si (KR)

(73) Assignee: KOREA UNIVERSITY OF TECHNOLOGY AND EDUCATION INDUSTRY-UNIVERSITY COOPERATION FOUNDATION, CCheonan-si (KR)

(21) Appl. No.: 18/923,605

(22) Filed: Oct. 22, 2024

Related U.S. Application Data
(63) Continuation of application No. PCT/KR2024/006908, filed on May 22, 2024.

(30) Foreign Application Priority Data
Nov. 15, 2023 (KR) 10-2023-0158339

(51) Int. Cl. H01M 8/0245; H01M 50/403; H01M 50/426; H01M 50/449; H01M 50/463

(52) U.S. Cl. CPC H01M 8/0245; H01M 50/403; H01M 50/426; H01M 50/449; H01M 50/463

(57) ABSTRACT

The present invention relates to a method for manufacturing a reinforced composite membrane using a gantry slot die coater, and to a reinforced composite membrane manufactured using the same and a fuel cell including the same, wherein the method for manufacturing a reinforced composite membrane includes preparing an ionomer solution, preparing a porous support, applying the ionomer solution onto one surface of the porous support using a gantry slot die coater, and applying the ionomer solution onto the other surface of the porous support using a gantry slot die coater.

### CROSS-REFERENCE TO RELATED APPLICATION

This application is a Continuation of PCT International Patent Application No. PCT/KR2024/006908 filed on May 22, 2024, which claims priority to Korean Patent Application No. 10-2023-0158339 filed on Nov. 15, 2023, respectively, which are all hereby incorporated by reference in their entirety.

### BACKGROUND

The present disclosure relates to a method for manufacturing a reinforced composite membrane using a gantry slot die coater, and to a reinforced composite membrane manufactured using the same and a fuel cell including the same.

This patent has resulted from research supported by the Industry-University Cooperation Advancement Support Program through the National Research Foundation of Korea (NRF), funded by the Ministry of Education in 2023 (Project serial number: 1345370650, Project number: LINC 3.0-2023-31), and supported by the Nano & Material Technology Development Program through the National Research Foundation of Korea (NRF), funded by the Ministry of Science and ICT in 2023 (Project number: 2023M3H4A309169821).

Reinforced composite membranes, serving as electrolytes in fuel cells, are applied in multiple areas and are particularly essential components that determine the performance and durability of fuel cells in the relevant field.

Fuel cells are cells that convert energy from fuels into electrical energy through electrochemical reactions, and, unlike typical rechargeable batteries, may offer uninterrupted generation of electricity when continuously supplied with fuels. In this case, the reinforced composite membranes (or electrolyte membranes) are positioned between a negative electrode and a positive electrode, serving to selectively permit the passage of ions (or protons) produced by the electrochemical reactions of fuels.

The reinforced composite membranes need to be made thin to enhance ionic conductivity and reduce resistance. However, reinforced composite membranes having a thickness of less than 50 μm were hardly achievable through typical manufacturing processes.

### SUMMARY

The present disclosure provides a method for manufacturing a reinforced composite membrane obtainable with a thickness of 50 μm or less, a reinforced composite membrane, and a fuel cell including the same.

The present disclosure also provides a continuous process, thereby reducing manufacturing time and costs.

The present disclosure also provides enhanced ionic conductivity and reduced resistance.

In accordance with an exemplary embodiment of the present invention, a method for manufacturing a reinforced composite membrane includes preparing an ionomer solution, preparing a porous support, applying the ionomer solution onto one surface of the porous support using a gantry slot die coater, and applying the ionomer solution onto the other surface of the porous support using a gantry slot die coater. In an embodiment, the method may further include drying the ionomer solution applied onto one surface of the porous support after the applying of the ionomer solution onto one surface of the porous support. In an embodiment, the method may further include drying the ionomer solution applied onto the other surface of the porous support after the applying of the ionomer solution onto other surface of the porous support.

The gantry slot die coater may have a nozzle moving speed of 3 to 7 mm/s.

The gantry slot die coater may have a discharge height of 50 to 75 μm.

The gantry slot die coater may have a discharge flow rate of 0.5 to 2.5 mL/min.

The ionomer solution may include a perfluorosulfonic acid polymer.

The porous support may include polytetrafluoroethylene (PTFE).

The drying of the ionomer solution applied onto one surface or the other surface of the porous support may be performed at a drying temperature of 130 to 150° C.

In accordance with another exemplary embodiment of the present invention, a reinforced composite membrane includes a porous support, and an ionomer disposed in pores of the porous support.

The ionomer is prepared through the method described above.

In an embodiment, the reinforced composite membrane may have a thickness of 10 to 25 μm.

In accordance with another exemplary embodiment of the present invention, a fuel cell includes a negative electrode, a positive electrode, and a reinforced composite membrane disposed between the negative electrode and the positive electrode. The reinforced composite membrane is manufactured through the method described above.

### BRIEF DESCRIPTION OF THE DRAWINGS

Exemplary embodiments can be understood in more detail from the following description taken in conjunction with the accompanying drawings, in which:

FIG. 1 shows SEM images of Examples 1 to 12;

FIG. 2 shows SEM images of Examples 13 to 15;

FIG. 3 shows EDS analysis results of Example 5;

FIG. 4 shows SEM images of Examples 16 to 21;

FIG. 5 shows SEM images of Examples 22 to 24;

FIG. 6 shows an EDS analysis result of Example 16;

FIG. 7 shows ionic conductivity analysis results;

FIG. 8 shows OCV and power density analysis results; and

FIG. 9 shows comparative analysis results of HFR and CTR.

### DETAILED DESCRIPTION OF EMBODIMENTS

Hereinafter, the present invention will be described in more detail. However, the present invention may be embodied in various different forms and is not limited by the embodiments described herein, and shall be defined only by the appended claims.

Hereinafter, preferred embodiments of the present invention will be described as follows with reference to the accompanying drawings. The invention may, however, be embodied in many different forms and should not be construed as being limited to the embodiments set forth herein. In addition, these embodiments of the present invention are provided so that the present invention will be thorough and complete, and will fully convey the scope of the invention to those skilled in the art.

A method for manufacturing a reinforced composite membrane according to an embodiment of the present invention includes preparing an ionomer solution, preparing a porous support, applying the ionomer solution onto one surface of the porous support using a gantry slot die coater, and applying the ionomer solution onto the other surface of the porous support using a gantry slot die coater. In an embodiment, the method may further include drying the ionomer solution applied onto one surface of the porous support after the applying of the ionomer solution one surface of the porous support. In an embodiment, the method may further include drying the ionomer solution applied onto the other surface of the porous support after the applying of the ionomer solution onto the other surface of the porous support.

In the preparing of the ionomer solution, the ionomer solution may be a mixture of a polymer material having ion permeability (or proton permeability) and a solvent, and may be Nafion from DuPont.

The polymer material may be a general material used as a reinforced composite membrane. In an embodiment, the polymer material may include a perfluorosulfonic acid polymer. The perfluorosulfonic acid polymer includes a perfluorinated hydrocarbon backbone (such as a copolymer of tetrafluoroethylene and trifluorovinyl) and a side chain containing a sulfonic acid group bonded to the backbone (such as a side chain containing a sulfonic acid group bonded to a perfluoroalkylene group).

The solvent is an organic solvent and is not particularly limited. The organic solvent may be an alcohol such as ethanol or methanol, dimethylformamide (DMF), and the like.

In the preparing of the porous support, the porous support may be formed of a polymer material exhibiting hydrophobicity and corrosion resistance. The polymer material may include at least any one of polytetrafluoroethylene, fluorinated ethylene propylene, polyvinylidene fluoride, polyperfluoroalkyl vinyl ether, or polyperfluorosulfonyl fluoride alkoxy vinyl ether, but may preferably be polytetrafluoroethylene (PTFE), considering corrosion resistance and formability.

Pores included in the porous support may be tens to hundreds of μm and may be uniformly formed over an entire area.

In the applying of the ionomer solution on one surface of the porous support using a gantry slot die coater, the gantry slot die coater is a device that forms a coating film with a precise thickness. A cross beam is provided on one or two slot dies. The slot dies may move in various directions such as x, y, and z axes, thereby enabling precise control and continuous processes. A coating solution is continuously sprayed onto a target to be coated through a nozzle of the slot die, and uniformly applied.

In an embodiment, the gantry slot die coater may have a nozzle moving speed of 3 to 7 mm/s. When the moving speed is too fast, a reinforced composite membrane exhibits a decrease in thickness, and when the moving speed is too slow, processability issues such as the ionomer solution overflowing to the outside of the porous support take place.

The gantry slot die coater may have a discharge height (height from a coating target object to an outlet of the nozzle of the gantry slot die coater) of 50 to 75 μm. When the discharge height is too high, a reinforced composite membrane exhibits a decrease in thickness, and when the discharge height is too low, processability issues such as the ionomer solution overflowing to the outside of the porous support take place.

The gantry slot die coater may have a discharge flow rate of 0.5 to 2.5 mL/min. When the discharge flow rate is too high, processability issues such as the ionomer solution overflowing to the outside of the porous support take place, and when the discharge flow rate is too low, a reinforced composite membrane exhibits a decrease in thickness.

The outlet through which the coating solution is discharged from the nozzle of the gantry slot die coater may have a size of 180 to 220 mm in width and 20 to 70 μm in breadth. When the size of the outlet is too large or small, uniform supply is hardly achieved.

The drying of the ionomer solution applied onto one side of the porous support may be performed through general methods used in the art. In an embodiment, the drying may be performed using a near-infrared (NIR) dryer.

The drying in this process may be performed at a drying temperature of 130 to 150° C. for 5 to 20 minutes. When the drying temperature is too low, the porous support is biased toward one surface or the other side, and when drying temperature is too high, a reinforced composite membrane is damaged.

The applying of the ionomer solution onto the other side of the porous support using the gantry slot die coater involves applying the ionomer solution onto an uncoated surface of the porous support, and may be performed in the same manner as the coating method described above.

The drying of the ionomer solution applied onto the other side of the porous support may be performed in the same manner as the drying method described above.

The reinforced composite membrane according to an embodiment of the present invention is manufactured through the method described above. The reinforced composite membrane includes a porous support, and an ionomer disposed in pores of the porous support. In an embodiment, the reinforced composite membrane may have a thickness of 10 to 25 μm. Accordingly, the reinforced composite membrane may exhibit optimal electrical properties as an electrolyte membrane for fuel cells.

A fuel cell according to an embodiment of the present invention includes a negative electrode, a positive electrode, and a reinforced composite membrane disposed between the negative electrode and the positive electrode. The reinforced composite membrane is manufactured through the method described above.

the negative electrode and the positive electrode are formed of electrically conductive materials, and the negative electrode serves to ionize fuel such as hydrogen, and the positive electrode serves to oxidize ions. The negative electrode and the positive electrode may be those commonly used in the art and are not particularly limited. In addition, the fuel cell may further include a case, and the negative electrode, the positive electrode, and an electrolyte membrane may be provided inside the case. In addition, the fuel cell may further include a fuel-side gas diffusion layer, a fuel-side catalyst layer, an air-side gas diffusion layer, and an air-side catalyst layer may be further included, and each component may be those commonly used in the art.

### Examples: Manufacturing of 20 μm Thick Reinforced Composite Membrane

Example 1: Nafion® PFSA Polymer Dispersions D-2021 from Dupont was used as an ionomer solution, PTFE having a thickness of 18 μm was used as a porous support, and YJC-LTC-G from YJCoaters was used as a gantry slot die coater. The gantry slot die coater had a nozzle size of 250 mm in width, 20 mm in thickness, and 70 mm in height, and an outlet size of 200 mm in width and 50 μm in breadth.

The ionomer solution was put into the gantry slot die coater, applied onto one surface of the PTFE, and then dried in an NIR dryer at 140° C. for 10 minutes. Thereafter, the other side of the PTFE was coated using the gantry slot die coater, and then dried in an NIR dryer at 140° C. for 10 minutes. The conditions of the gantry slot die coater in the coating process were a discharge height of 50 μm, a discharge flow rate of 1 mL/min, and a nozzle moving speed of 5 mm/s.

Example 2: A reinforced composite membrane was manufactured in the same manner as in Example 1, except that the discharge flow rate was set to 2 mL/min. During the manufacturing process, the ionomer solution overflowed onto the PTFE.

Example 3: A reinforced composite membrane was manufactured in the same manner as in Example 1, except that the discharge flow rate was set to 3 mL/min. During the manufacturing process, the ionomer solution overflowed onto the PTFE.

Example 4: A reinforced composite membrane was manufactured in the same manner as in Example 1, except that the discharge height was set to 70 μm.

Example 5: A reinforced composite membrane was manufactured in the same manner as in Example 4, except that the discharge flow rate was set to 2 mL/min.

Example 6: A reinforced composite membrane was manufactured in the same manner as in Example 4, except that the discharge flow rate was set to 3 mL/min. During the manufacturing process, the ionomer solution overflowed onto the PTFE.

Example 7: A reinforced composite membrane was manufactured in the same manner as in Example 1, except that the discharge height was set to 90 μm.

Example 8: A reinforced composite membrane was manufactured in the same manner as in Example 7, except that the discharge flow rate was set to 2 mL/min.

Example 9: A reinforced composite membrane was manufactured in the same manner as in Example 7, except that the discharge flow rate was set to 3 mL/min.

Example 10: A reinforced composite membrane was manufactured in the same manner as in Example 5, except that the nozzle moving speed was set to 1 mm/s.

Example 11: A reinforced composite membrane was manufactured in the same manner as in Example 5, except that the nozzle moving speed was set to 5 mm/s.

Example 12: A reinforced composite membrane was manufactured in the same manner as in Example 5, except that the nozzle moving speed was set to 10 mm/s.

Example 13: A reinforced composite membrane was manufactured in the same manner as in Example 5, except that the drying temperature was set to 60° C.

Example 14: A reinforced composite membrane was manufactured in the same manner as in Example 5, except that the drying temperature was set to 100° C.

Example 15: A reinforced composite membrane was manufactured in the same manner as in Example 5, except that the drying temperature was set to 140° C.

### Experimental Example: SEM Analysis (1)

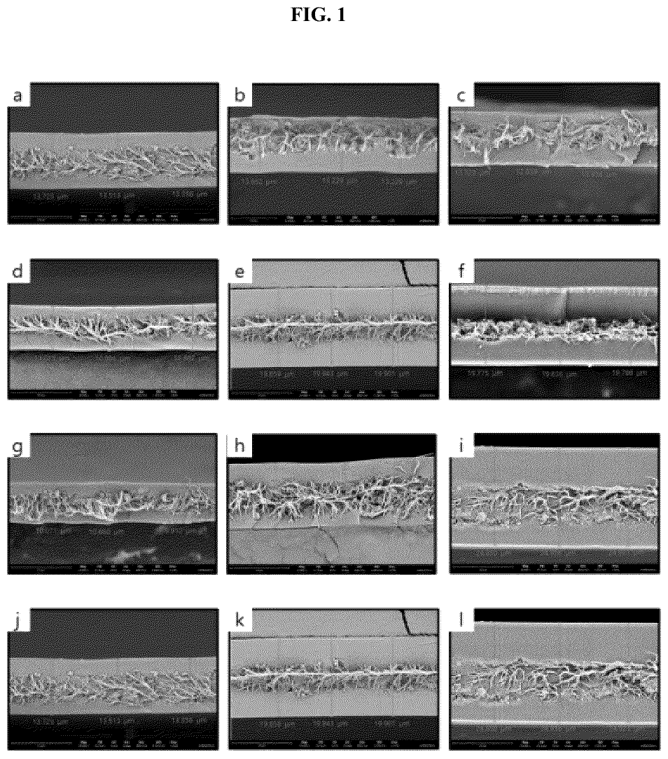

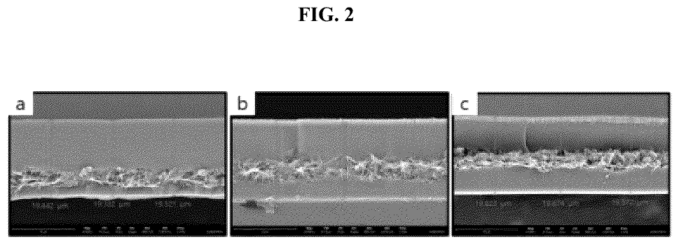

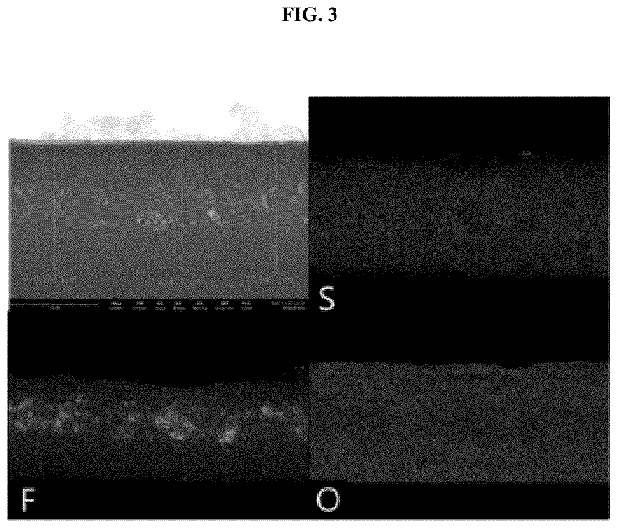

A breakage surface of a sample, which was rapidly frozen through liquid nitrogen and subsequently broken, was Au-coated and then imaged using a scanning electron microscope (SEM, Thermo Fisher Scientific, Phenom ProX G6). SEM images of Examples 1 to 12 manufactured by adjusting conditions of the gantry slot die coater are each shown in FIG. 1a to FIG. 1i, and SEM images of Examples 13 to 15 manufactured by adjusting drying temperature conditions are each shown in FIG. 2a to FIG. 2c. In addition, EDS analysis was performed on Example 5, and the results are shown in FIG. 3.

Referring to FIG. 1, in Examples 1 to 12 manufactured by adjusting conditions of the gantry slot die coater, the thickness of the reinforced composite membranes failed to reach 20 μm in Examples 1 to 4, 7, 8, and 12, and the issue of the ionomer solution overflowing during the manufacturing process took place in Examples 2, 3, 6, and 10. Example 9 exhibited an excessive increase in thickness. Accordingly, it is seen that Examples 5 and 11 are the most suitable gantry slot die coater conditions for manufacturing a 20 μm thick reinforced composite membrane.

Referring to FIG. 2, in Examples 13 to 15 manufactured by adjusting drying temperature conditions, it is seen that in Examples 13 and 14 where the drying temperature is low, the PTFE membrane is biased to one side. Accordingly, it is seen that Example 15 is the most suitable drying temperature condition for manufacturing a 20 μm thick reinforced composite membrane.

Referring to FIG. 3, in Example 5, the reinforced composite membrane had an average thickness of 20.4 μm and a thickness deviation of 0.123 μm (0.60%). In addition, it was determined that the ionomer was successfully impregnated into the porous fluorine-based PTFE since sulfur(S) and oxygen (O) elements of the sulfone group were uniformly distributed throughout the entire cross-section of the reinforced composite membrane.

### Examples: Manufacturing of 15 μm Thick Reinforced Composite Membrane

Example 16: Nafion® PFSA Polymer Dispersions D-2021 from Dupont was used as an ionomer solution, PTFE having a thickness of 13 μm was used as a porous support, and YJC-LTC-G from YJCoaters was used as a gantry slot die coater. The ionomer solution was put into the gantry slot die coater, applied onto one surface of the PTFE, and then dried in an NIR dryer at 140° C. for 10 minutes. Thereafter, the other side of the PTFE was coated using the gantry slot die coater, and then dried in an NIR dryer at 140° C. for 10 minutes. The conditions of the gantry slot die coater in the coating process were a discharge height of 55 μm, a discharge flow rate of 1.25 mL/min, and a nozzle moving speed of 5 mm/s.

Example 17: A reinforced composite membrane was manufactured in the same manner as in Example 16, except that the discharge flow rate was set to 1.5 mL/min.

Example 18: A reinforced composite membrane was manufactured in the same manner as in Example 16, except that the discharge flow rate was set to 1.75 mL/min. During the manufacturing process, the ionomer solution overflowed onto the PTFE.

Example 19: A reinforced composite membrane was manufactured in the same manner as in Example 16, except that the nozzle moving speed was set to 1 mm/s. During the manufacturing process, the ionomer solution overflowed onto the PTFE.

Example 20: A reinforced composite membrane was manufactured in the same manner as in Example 16, except that the nozzle moving speed was set to 5 mm/s.

Example 21: A reinforced composite membrane was manufactured in the same manner as in Example 16, except that the nozzle moving speed was set to 10 mm/s.

Example 22: A reinforced composite membrane was manufactured in the same manner as in Example 16, except that the drying temperature was set to 60° C.

Example 23: A reinforced composite membrane was manufactured in the same manner as in Example 16, except that the drying temperature was set to 100° C.

Example 24: A reinforced composite membrane was manufactured in the same manner as in Example 16, except that the drying temperature was set to 140° C.

### Experimental Example: SEM Analysis (2)

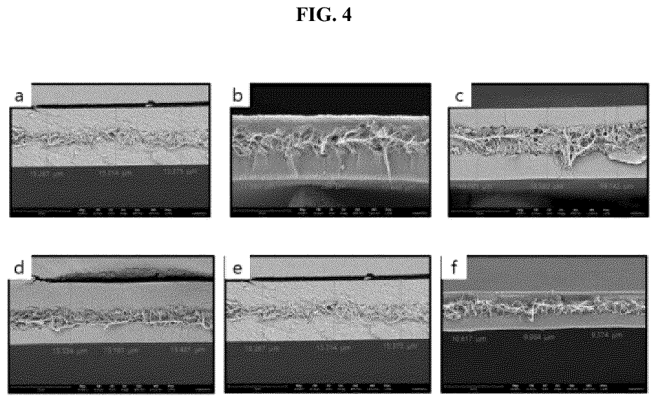

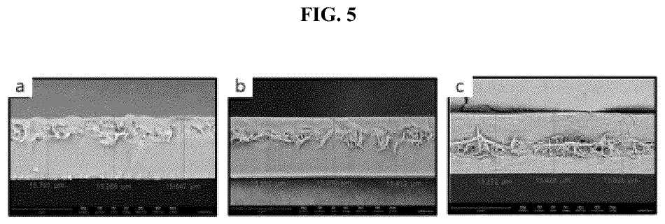

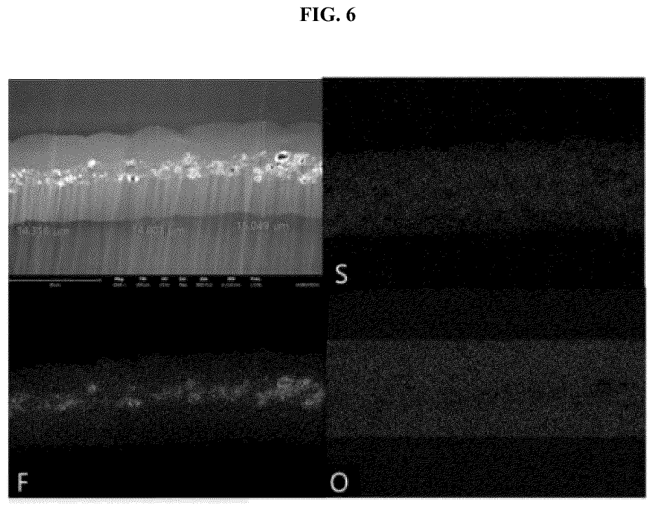

SEM was imaged in the same manner as the method described above. SEM images of Examples 16 to 21 manufactured by adjusting conditions of the gantry slot die coater are each shown in FIG. 4a to FIG. 4f, and SEM images of Examples 22 to 24 manufactured by adjusting drying temperature conditions are each shown in FIG. 5a to FIG. 5c. In addition, EDS analysis was performed on Example 16, and the results are shown in FIG. 6.

Referring to FIG. 4, in Examples 16 to 21 manufactured by adjusting conditions of the gantry slot die coater, the thickness of the reinforced composite membrane failed to reach 15 μm in Example 21, and the issue of the ionomer solution overflowing during the manufacturing process took place in Example 19. Examples 17 and 18 exhibited an excessive increase in thickness. Accordingly, it is seen that Examples 16 and 20 are the most suitable gantry slot die coater conditions for manufacturing a 15 μm thick reinforced composite membrane.

Referring to FIG. 5, in Examples 22 to 24 manufactured by adjusting drying temperature conditions, it is seen that in Examples 22 and 23 where the drying temperature is low, the PTFE membrane is biased to one side. Accordingly, it is seen that Example 24 is the most suitable drying temperature condition for manufacturing a 15 μm thick reinforced composite membrane.

Referring to FIG. 6, in Example 16, the reinforced composite membrane had an average thickness of 14.7 μm and a thickness deviation of 0.147 μm (1.00%). In addition, it was determined that the ionomer was successfully impregnated into the porous fluorine-based PTFE since sulfur(S) and oxygen (O) elements of the sulfone group were uniformly distributed throughout the entire cross-section of the reinforced composite membrane.

### Examples: Manufacturing of 25 μm Thick Reinforced Composite Membrane

Example 25: Nafion® PFSA Polymer Dispersions D-2021 from Dupont was used as an ionomer solution, PTFE having a thickness of 18 μm was used as a porous support, and YJC-LTC-G from YJCoaters was used as a gantry slot die coater. The ionomer solution was put into the gantry slot die coater, applied onto one surface of the PTFE, and then dried in an NIR dryer at 140° C. for 10 minutes. Thereafter, the other side of the PTFE was coated using the gantry slot die coater, and then dried in an NIR dryer at 140° C. for 10 minutes. The conditions of the gantry slot die coater in the coating process were a discharge height of 90 μm, a discharge flow rate of 3 mL/min, and a nozzle moving speed of 5 mm/s.

### Experimental Example: Ionic Conductivity Analysis

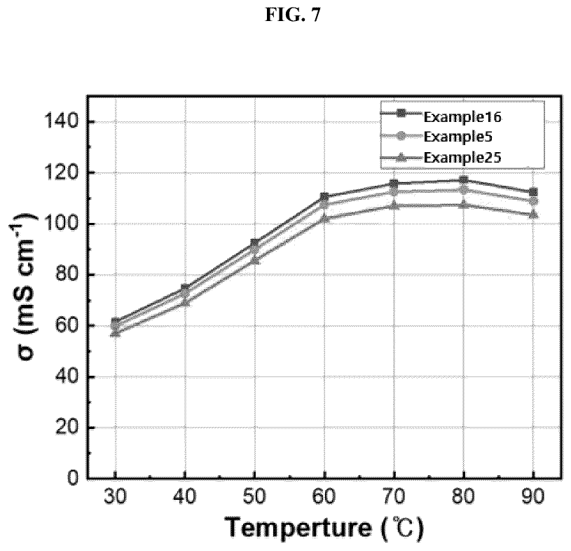

Ionic conductivity analysis was conducted on Examples 5, 16, and 25 using an electrochemical impedance spectroscopy (EIS) system (Biologic, HCP-803) and a membrane conductivity measurement cell (Wonatech, MCC membrane conductivity cell) with a 4-probe method. Ionic conductivity analysis was conducted by measuring the resistance of the reinforced composite membrane under the following conditions: 100% RH humidity, temperature ranging from 30° C. to 90° C., frequency range from 100 kHz to 100 mHz, voltage range from −1 to 1 V, and amplitude of 50 mV. The ionic conductivity was calculated using the following equation. The results of the ionic conductivity analysis are shown in FIG. 7.

$$σ ( S / m ) = \frac{l ( cm )}{R ( Ω ) \times S ( {cm}^{2} )} \qquad [ Equation 1 ]$$

Referring to FIG. 7, at the typical operating temperature of 70° C. for polymer electrolyte membrane fuel cells, the ionic conductivities of Examples 5, 16, and 25 were found to be 112.5 mS/cm², 115.7 mS/cm², and 107.4 mS/cm², respectively.

### Experimental Example: Unit Cell Performance Evaluation

Unit cell performance evaluation was conducted on Examples 5, 16, and 25. The reinforced composite membranes were hot-pressed with 25 cm² catalyst electrodes using a decal transfer process to fabricate a membrane electrode assembly (MEA). As for the catalyst used, Ketjen Black EC300J (Premetek, Pt/C, Pt 60 wt %) was mixed with an ionomer (Dupont, D2021) at an I/C ratio of 0.8 and then transferred at 0.4 mg/cm².

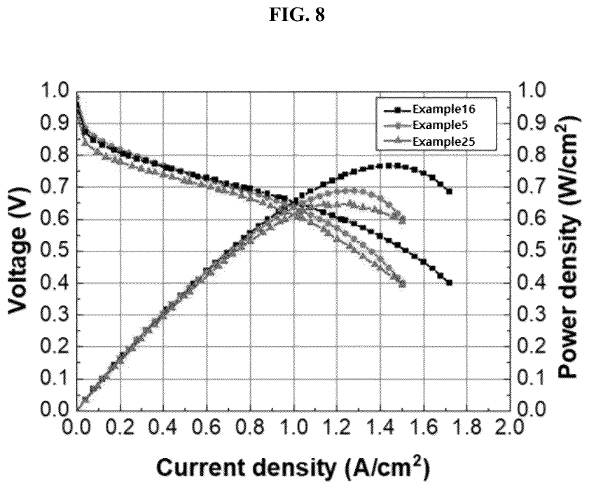

To evaluate the performance of the fabricated MEA in a single cell, electrical characteristics such as open circuit voltage (OCV), current density at 0.6 V, and power density were evaluated by injecting hydrogen and air at a flow rate ratio of 1.5:2.0 while varying the current under the conditions of 70° C. and 100% RH at a fuel cell test station (CNL energy). The measurement results are shown in FIG. 8. Example 5 was found to have an OCV of 0.981 V, a current density of 1.121 A/cm² at 0.6 V, and a maximum power density of 0.689 W/cm², Example 16 was found to have an OCV of 0.981 V, a current density of 1.221 A/cm² at 0.6 V, and a maximum power density of 0.767 W/cm², and Example 25 was found to have an OCV of 0.934 V, a current density of 1.048 A/cm² at 0.6 V, and a maximum power density of 0.650 W/cm².

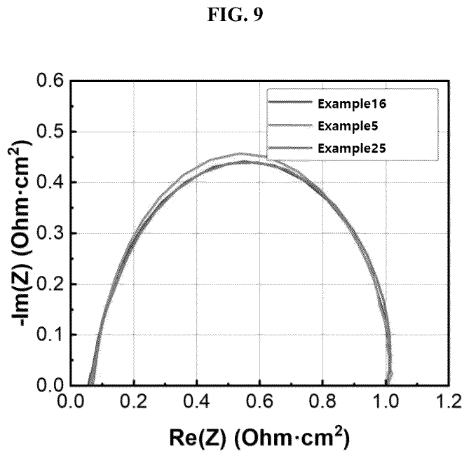

Thereafter, EIS analysis was performed on each MEA, and HFR and CTR were compared through Nyquist plot. The results are shown in FIG. 9. Referring to FIG. 9, Example 5 was found to have an HFR of 0.0610 ohm·cm² and a CTR of 1.000 ohm·cm², Example 16 was found to have an HFR of 0.0549 ohm·cm² and a CTR of 0.999 ohm·cm², and Example 25 was found to have an HFR of 0.0690 ohm·cm² and a CTR of 1.008 ohm·cm².

The MEA fabricated using the reinforced composite membrane of Example 16 had a lower HFR than the MEA fabricated using the reinforced composite membranes of Examples 5 and 25. It is considered that the enhanced performance of MEA is attributed to the faster transfer of hydrogen ions in the reinforced composite membrane of Example 16, which was thinner due to the difference in thickness.

A method for manufacturing a reinforced composite membrane according to an embodiment of the present invention provides a reinforced composite membrane having a thickness of 50 μm or less.

In addition, the present invention provides a continuous process, thereby reducing manufacturing time and costs.

In addition, the present invention also provides enhanced ionic conductivity and reduced resistance.

The present invention is not limited to the above-described embodiments and the accompanying drawings, and is intended to be limited by the appended claims. Accordingly, various forms of substitution, modification, and alteration may be made by those skilled in the art without departing from the technical spirit of the present invention described in the claims, which may be also within the scope of the present invention.

What is claimed is:

1. A method for manufacturing a reinforced composite membrane, the method comprising:
preparing an ionomer solution;
preparing a porous support;
applying the ionomer solution onto one surface of the porous support using a gantry slot die coater; and
applying the ionomer solution onto the other surface of the porous support using a gantry slot die coater.

2. The method of claim 1, wherein in the applying of the ionomer solution onto one surface of the porous support and the applying of the ionomer solution onto the other surface of the porous support,
the gantry slot die coater has a nozzle moving speed of 3 to 7 mm/s.

3. The method of claim 1, wherein in the applying of the ionomer solution onto one surface of the porous support and the applying of the ionomer solution onto the other surface of the porous support,
the gantry slot die coater has a discharge height of 50 to 75 μm.

4. The method of claim 1, wherein in the applying of the ionomer solution onto one surface of the porous support and the applying of the ionomer solution onto the other surface of the porous support,
the gantry slot die coater has a discharge flow rate of 0.5 to 2.5 mL/min.

5. The method of claim 1, wherein the ionomer solution comprises a perfluorosulfonic acid polymer.

6. The method of claim 1, wherein the porous support comprises polytetrafluoroethylene (PTFE).

7. The method of claim 1, having a thickness of 10 to 25 μm.

8. The method of claim 1, further comprising drying the ionomer solution applied onto one surface of the porous support after the applying of the ionomer solution onto one surface of the porous support, and
drying the ionomer solution applied onto the other surface of the porous support after the applying of the ionomer solution onto the other surface of the porous support.

9. The method of claim 8, wherein the drying of the ionomer solution applied onto one surface or the other surface of the porous support is performed at a drying temperature of 130 to 150° C.

10. A reinforced composite membrane comprising:
a porous support; and
an ionomer disposed in pores of the porous support,
wherein the ionomer is applied onto one surface and the other surface of the porous support using a gantry slot die coater, and thus prepared.

11. A fuel cell comprising:
a negative electrode;
a positive electrode; and
a reinforced composite membrane disposed between the negative electrode and the positive electrode,
wherein the reinforced composite membrane comprises a porous support and an ionomer disposed in pores of the porous support, and the ionomer is applied onto one surface and the other surface of the porous support using a gantry slot die coater, and thus prepared.
